(19) United States
(12) Patent Application Publication
(10) Pub. No.: US 2025/0080951 A1
(43) Pub. Date: Mar. 6, 2025

(54) OBJECT TRACKING SYSTEM AND OBJECT TRACKING METHOD

(71) Applicant: WISTRON NEWEB CORPORATION, Hsinchu (TW)

(72) Inventors: YI-AN CHEN, HSINCHU (TW); LEE AING, HSINCHU (TW); I-HSUAN HSIEH, HSINCHU (TW); HOREN CHEN, HSINCHU (TW)

(21) Appl. No.: 18/822,554

(22) Filed: Sep. 3, 2024

Related U.S. Application Data
(60) Provisional application No. 63/580,441, filed on Sep. 5, 2023.

(30) Foreign Application Priority Data
Sep. 2, 2024 (TW) 113133013

(51) Int. Cl. H04W 4/029; G06T 7/73

(52) U.S. Cl. CPC H04W 4/029; G06T 7/73; G06T 2207/20044

(57) ABSTRACT

An object tracking system and an object tracking method are provided. The object tracking system includes a transmitter, a receiver and at least one processing circuit. The transmitter is configured to transmit wireless signals through a target space. The receiver is configured to receive the wireless signals. The at least one processing circuit is configured to perform following processes: obtaining the wireless signals received by the receiver; generating motion information associated with at least one target object by executing a motion machine-learning model that processes the received wireless signals; and generating three-dimensional tracking information of the at least one target object with respect to the target space by fusing spatial information of the target space and the motion information.

### CROSS-REFERENCE TO RELATED PATENT APPLICATION

This application claims the benefit of priority to the U.S. Provisional Patent Application Ser. No. 63/580,441, filed on Sep. 5, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system and a method, and more particularly to an object tracking system and an object tracking method.

### BACKGROUND OF THE DISCLOSURE

Indoor location-based services are becoming increasingly important for object motion tracking and monitoring. A popular approach to estimate the real-time location of a moving object typically uses an inertial measurement unit (IMU) to estimate both the moving direction and distance. However, the accuracy of distance estimation is often unsatisfactory, which is a major reason why such indoor navigation systems are not yet widely adopted.

Among various of the indoor location-based services, the motion detection system is prevalent in both public buildings and private residences. Conventional motion detection systems typically use sensors monitored and controlled by a central panel, usually mounted within the building. Sensors can be installed at windows, doors, and other locations to detect intrusions or for medical caring, with one sensor per door or window. A typical house, approximately dozens square meter in size, may require at least 6-8 sensors, leading to considerable hardware costs.

Therefore, there is a need for systems and methods for tracking and monitoring motion to address the above-mentioned problems and to avoid the above-mentioned drawbacks.

### SUMMARY OF THE DISCLOSURE

In response to the above-referenced technical inadequacies, the present disclosure provides an object tracking system and an object tracking method capable of extending the use of WI-FI sensing technology in tracking application by combining spatial information with motion information, so as to achieve precise three-dimensionally position and motion tracking.

In order to solve the above-mentioned problems, one of the technical aspects adopted by the present disclosure is to provide an object tracking system that includes a transmitter, a receiver, and at least one processing circuit. The transmitter is configured to transmit wireless signals through a target space, and the receiver is configured to receive the wireless signals. The at least one processing circuit is configured to perform following processes: obtaining the wireless signals received by the receiver; generating motion information associated with at least one target object by executing a motion machine-learning model that processes the received wireless signals; and generating three-dimensional tracking information of the at least one target object with respect to the target space by fusing spatial information of the target space and the motion information.

In order to solve the above-mentioned problems, another one of the technical aspects adopted by the present disclosure is to provide an object tracking method, including: configuring a transmitter to transmit wireless signals through a target space; configuring a receiver to receive the wireless signals; and configuring at least one processing circuit to perform following processes: obtaining the wireless signals received by the receiver; generating motion information associated with at least one target object by executing a motion machine-learning model that processes the received wireless signals; and generating three-dimensional tracking information of the at least one target object with respect to the target space by fusing spatial information of the target space and the motion information.

In order to solve the above-mentioned problems, yet another one of the technical aspects adopted by the present disclosure is to provide an object tracking method adapted to a user equipment that includes a processor and a memory storing a plurality of executable instructions, and the object tracking method includes: configuring the processor to execute the plurality of executable instructions to perform following processes: configuring an image capturing device to capture at least one panoramic image of a target space, obtaining spatial information generated by executing a spatial machine-learning model that converts the at least one panoramic image into three-dimensional layout information of the target space; transmitting the spatial information to a network device or a cloud server, wherein the network device or the cloud server is configured to obtain wireless signals received by a receiver, generate motion information associated with at least one target object by executing a motion machine-learning model that processes the received wireless signals, and generate three-dimensional tracking information of the at least one target object with respect to the target space by fusing the spatial information and the motion information; and receiving the three-dimensional tracking information of the at least one target object with respect to the target space, and displaying the three-dimensional tracking information by a user interface of a tracking application program executed by the user equipment.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of an object tracking system according to one embodiment of the present disclosure;

FIG. 2 is a schematic view showing the object tracking system with respect to a 3D layout of a target space according to one embodiment of the present disclosure;

FIG. 3 is a flowchart of an object tracking method according to one embodiment of the present disclosure;

FIG. 4 is a flowchart of a setup process according to one embodiment of the present disclosure;

FIG. 5 is a schematic view of the setup process according to one embodiment of the present disclosure;

FIG. 6 is a flowchart of processes being performed when the motion machine-learning model MML is executed by the processing circuit according to one embodiment of the present disclosure;

FIG. 7 is a flowchart for training the motion machine-learning model according to one embodiment of the present disclosure;

FIG. 8 is a schematic view showing steps of training an initial model by a trained pose-detecting model according to one embodiment of the present disclosure;

FIG. 9 is a flowchart for generating three-dimensional tracking information of a target object with respect to the target space according to one embodiment of the present disclosure;

FIG. 10 is a flowchart for generating bird's-eye view tracking information according to one embodiment of the present disclosure; and

FIG. 11 is a bird's eye view according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the present disclosure, an object tracking system and an object tracking method are provided to identify a target object in an environment and track the movement of the target object within the environment using WI-FI sensing technology. A trained spatial machine-learning model can be executed to convert a panorama image into spatial information, and a trained motion machine-learning model can be executed to convert WI-FI signal into motion information. The spatial information and the motion information are combined to further identify actions and track movements and location of the target object in the environment.

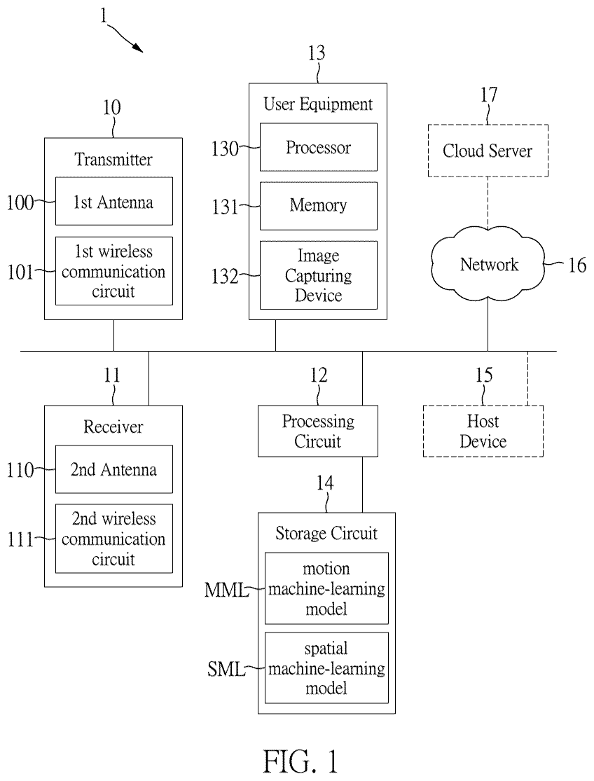

FIG. 1 is a functional block diagram of an object tracking system according to one embodiment of the present disclosure. Referring to FIG. 1, one embodiment of the present disclosure provides an object tracking system 1, and the object tracking system 1 includes a transmitter 10, a receiver 11 and a processing circuit 12.

The transmitter 10 can include a first antenna 100 and a first wireless communication circuit 101 connected to the first antenna 100. The first wireless communication circuit 101 can include components such as amplifiers, a modulator, an oscillator, a buffer, and the like, these components work together to generate, modulate, amplify and transmit radio frequency (RF) signals. The first wireless communication circuit 101 can support plural of protocols and may be used to transmit wireless signals having different operation frequencies. Furthermore, the protocols may be wireless communication standard, such as IEEE 802.11, 3G/4G/5G/6G standards.

Similarly, the receiver 11 can include a second antenna 110 and a second wireless communication circuit 111 connected to the second antenna 110. The wireless communication circuit 111 can include components such as amplifiers, a mixer, a local oscillator, a demodulator, and the like, these components work together to receive, amplify, process radio frequency (RF) signals, and convert the RF signals into usable information. Similarly, the second wireless communication circuit 111 can support the protocols corresponding to the transmitter 10 and may be used to receive the wireless signals having different operation frequencies.

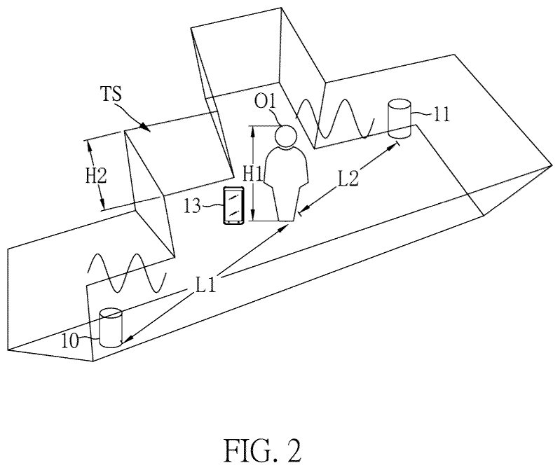

Referring to FIG. 2, when the object tracking system 1 is set in a target space TS, such as an indoor environment of an apartment, the transmitter 10 and the receiver 11 can be separately disposed in two network devices that are disposed at corners of the indoor environment. The two network devices can be, for example, a router and an extender, and in this case, the receiver 11 and the transmitter 10 can be used to provide WI-FI connection while functioning as monitoring devices.

In the present disclosure, a quantity of the processing circuit 12 can be one or more. For example, two processing circuits can be respectively disposed in the two network devices, which respectively include the receiver 11 and the transmitter 10 as mentioned above. In certain embodiments, the processing circuit 12 can be disposed in a cloud server 17 or a host device 15 locally disposed in the indoor environment and communicatively connected with the transmitter 10 and the receiver 11. The processing circuit 12 can be electrically connected to a storage circuit 14, which can be configured to store a spatial machine-learning model SML and a motion machine-learning model MML, but the present disclosure is not limited thereto, the spatial machine-learning model SML can be stored in the memory of the user equipment 13, and the motion machine-learning model MML can be stored in any storage circuit in the network device at which the processing circuit 12 is disposed.

As shown in FIG. 1, the object tracking system 1 further includes a user equipment 13, such as a mobile phone, which can be communicatively connected to the router and/or the extender. The user equipment 13 can include a processor 130, a memory 132 and an image capturing device 134. The user equipment 13 can also include network interfaces for communicatively connected to the transmitter 10, the receiver 11, the processing circuit(s) 12, the host device 15, the network 16 and/or cloud server 17.

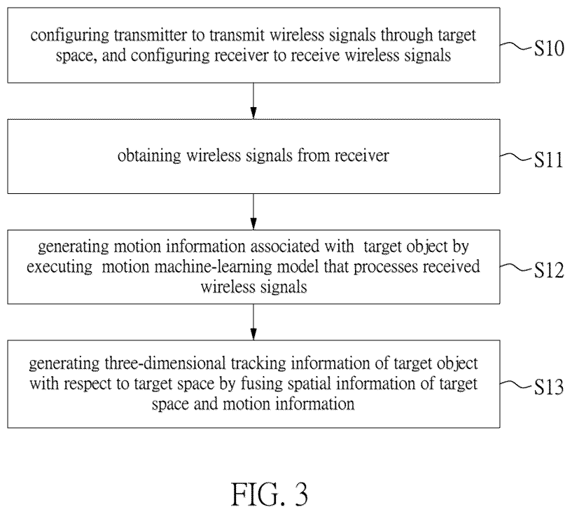

Referring to FIG. 3, the present disclosure provides an object tracking method, which is suitable for the object tracking system 1 of FIG. 1, but the present disclosure is not limited thereto. As shown in FIG. 3, the object tracking method can include the following steps:

Step S10: configuring a transmitter to transmit wireless signals through a target space, and configuring a receiver to receive the wireless signals.

In the present step, the transmitter 10 can transmit radio signals, such as WI-FI signals through a multipath channel, and the receiver 11 can receive the signals from the multipath channel that are impacted by a target object O1 in the indoor environment.

It should be noted that the object tracking method of the present disclosure further includes a setup process that can be performed before step S10. In the setup process, the user equipment 13 can be configured to setup and execute an application program by the processor 130, and the application program can provide a user interface for the user to manage the network devices and control the image capturing device 134.

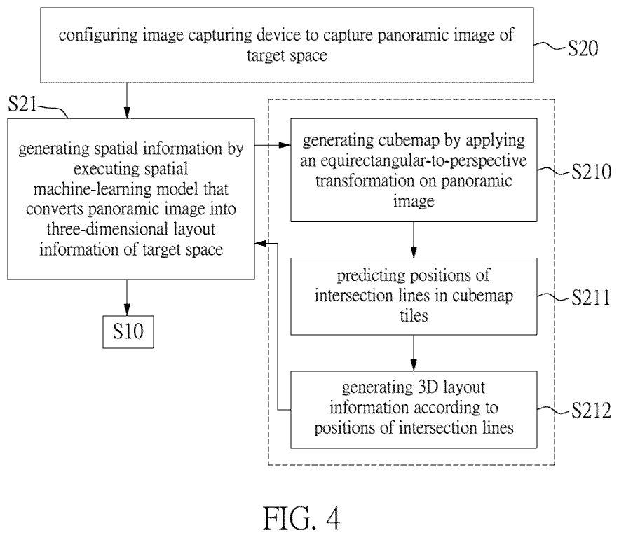

Referring to FIG. 4, the setup process includes the following steps:

Step S20: configuring an image capturing device to capture at least one panoramic image of the target space. For example, the user can control the image capturing device 134 to capture a 360-degree panoramic image or two 180-degree panoramic images through the user interface provided by the application program.

The setup process further includes the following steps performed by the processing circuit 12 (and/or the processor 130 of the user equipment 13):

Step S21: generating the spatial information by executing a spatial machine-learning model that converts the at least one panoramic image into three-dimensional layout information of the target space. It should be noted that the spatial information generated in the setup process can be stored in the memory 132 and/or transmitted to the processing circuit 12.

Step S21 further includes the following steps:

Step S210: generating a cubemap by applying an equirectangular-to-perspective transformation on the at least one panoramic image.

Step S211: predicting positions of a plurality of intersection lines in the plurality of cubemap tiles.

Step S212: generating the three-dimensional layout information according to the positions of the plurality of intersection lines.

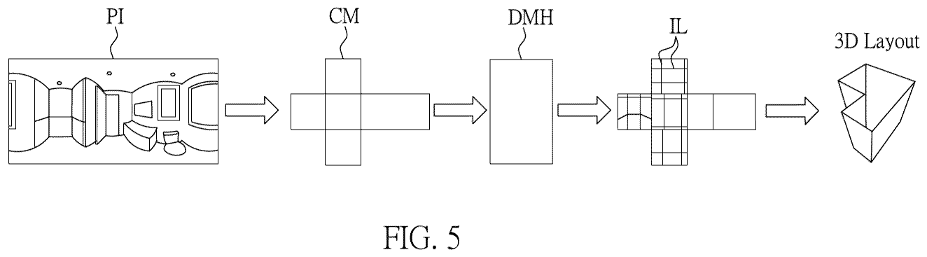

Referring to FIG. 5, the panoramic image is taken as an input of the spatial machine-learning model SML that is executed by the processor 130. During the execution of the spatial machine-learning model SML, an equirectangular-to-perspective (E2P) transformation is applied on the panoramic image PI to generate a cubemap CM. More specifically, the panoramic image is aligned based on an LSD algorithm and vanishing points, then the E2P transformation is conducted for several times on the equal-rectangular image to generate the cubemap CM that includes a plurality of cubemap tiles.

Furthermore, a deep Manhattan Hough (DMH) transform model is then utilized to predict positions of the wall-wall, wall-floor and wall-ceiling intersection lines IL in each of the cubemap tiles. Afterward, a 3D room layout can be recovered by post-processing procedures to serve as the spatial information that includes 3D layout of the target space TS. It should be noted that the spatial information can at least include one or more of geometric information, semantic Information, topological information, and spatial adjacency information. The geometric information includes detailed representations of the physical dimensions and shapes of the target space TS, including walls, floors, ceilings, doors, and windows, the semantic information includes descriptions of the various elements within the space, such as room names, types of furniture, and other objects, the topological information defines relationships and connectivity between different spaces and elements, such as how rooms are connected by doors or hallways, and the spatial adjacency information provides information about the proximity and arrangement of different spaces within the target space TS.

Referring to FIG. 3, the object tracking method proceeds to step S11: obtaining the wireless signals from the receiver. During the transmission of the wireless signals, channel state information (CSI) for the multipath channel can be extracted using channel estimation. For example, each component in the CSI can be composed by an amplitude and a phase of a sub-carrier, and when multiple subcarriers arrive at the receiver 11 along the multipath channel, each sub-carrier may have its own amplitude and phase.

Step S12: generating motion information associated with at least one target object by executing a motion machine-learning model that processes the received wireless signals.

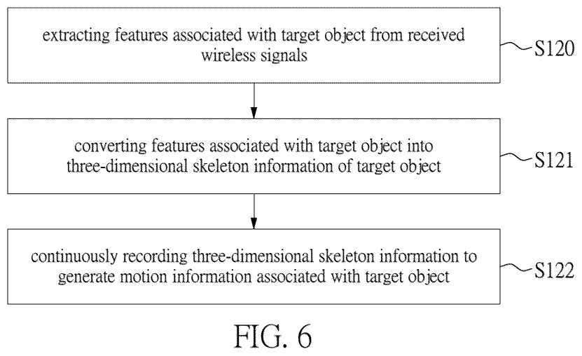

Referring to FIG. 6, the motion machine-learning model MML is executed by the processing circuit 12 to perform following processes:

Step S120: extracting features associated with the at least one target object from the received wireless signals.

For example, when the target object O1 is located in the target space TS, each component in the CSI can be changed by the presence of the target object O1 (human), and when multiple subcarriers arrive at the receiver 11 along the multipath channel, the features associated to the target object O1 can be extracted for motion analyzation.

Step S121: converting the features associated with the at least one target object into three-dimensional skeleton information of the at least one target object.

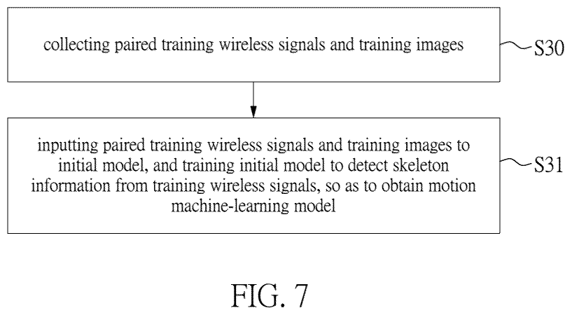

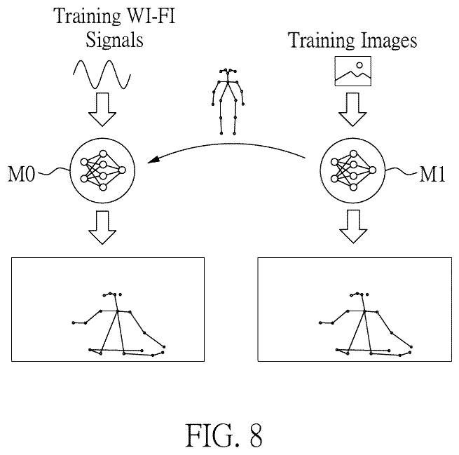

It should be noted that a part of the motion machine-learning model MML has been trained to three-dimensionally detect human skeletons from the wireless signals. Referring to FIGS. 7 and 8, the motion machine-learning model MML is trained by following processes:

Step S30: collecting paired training wireless signals and training images. In step S30, each of training images is marked with training skeleton information, for example, each of training images can be marked with the training skeleton information by using a trained pose-detecting model M1.

Step S31: inputting the paired training wireless signals and training images to an initial model MO, and training the initial model MO to detect skeleton information from the training wireless signals, so as to obtain the motion machine-learning model MML.

More specifically, the trained pose-detecting model M1 is a machine-learning model that has been trained to detect human skeletons from an image with human therewithin. Therefore, the trained pose-detecting model M1 can serve as a teacher model, such that the initial model MO, serving as a student model, can learn how to detect human skeletons from the wireless signals corresponding to the teacher model's output, that is, images labeled with human skeletons. In some embodiments, the initial model MO can include, for example, one or more of a multilayer perceptron model, a convolutional neural network model, a recurrent neural network model, a long-short term memory model and a gated recurrent unit model, and the motion machine-learning model MML can be obtained in response to performance of the initial model MO meeting a predetermined condition.

Step S122: continuously recording the three-dimensional skeleton information to generate the motion information associated with at least one target object.

Step S13: generating three-dimensional tracking information of the at least one target object with respect to the target space by fusing spatial information of the target space and the motion information.

In step S13, the spatial information provides detail information about the target space TS while the motion information provides real-time movement detection of the target object O1 in the environment. By combining the two, a real-time monitoring of movement for the target object O1 at a precise location of the target space TS can be achieved, which is also helpful if accurate location of a target object in action needs to be identified.

Referring to FIG. 2 again, in step S13, a height H1 of the 3D skeleton of the target object O1 and a height H2 of the target space TS can be estimated by combining the spatial information and the motion information obtained in the previous steps. This calculation can also determine a distance L1 between the target object and the transmitter 10 and a distance L2 between the target object O1 and the receiver 11 (e.g., a distance from the router or the extender to the target object O1), so as to achieve a bird's eye view of human tracking.

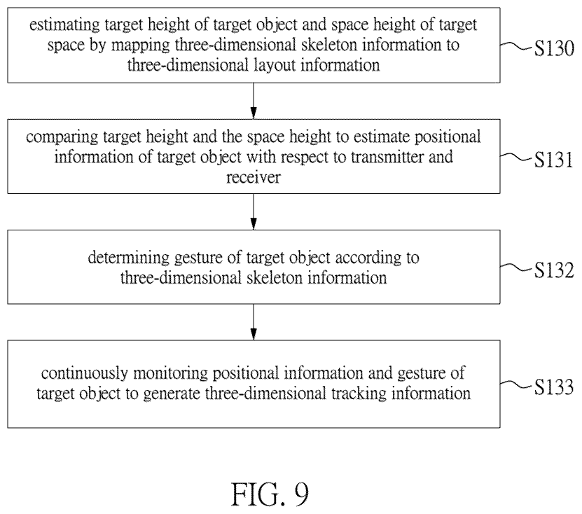

Referring to FIG. 9, the three-dimensional tracking information of the target object O1 with respect to the target space TS can be generated by performing following processes using the processing circuit 12:

Step S130: estimating a target height of the at least one target object and a space height of the target space by mapping the three-dimensional skeleton information to the three-dimensional layout information.

Step S131: comparing the target height and the space height to estimate positional information of the at least one target object with respect to the transmitter and the receiver.

Step S132: determining a gesture of the at least one target object according to the three-dimensional skeleton information. Specifically, the three-dimensional skeleton information can include a bone structure, joint locations, a pose and orientations. The bone structure is a detailed representation of all bones in the human body, including their shapes, sizes, and positions. The joint locations define precise coordinates of joints where bones connect, allowing for accurate modeling of movement and articulation. The pose and orientation provides information about the pose and orientation of the skeleton within the target space TS, which can be used to track and analyze human motion.

Step S133: continuously monitoring the positional information and the gesture of the at least one target object to generate the three-dimensional tracking information. Therefore, the user equipment 13 can then receive and display the three-dimensional tracking information of the target object O1 with respect to the target space TS. In step S133, the three-dimensional tracking information can further include spatial relationships, temporal data, surface and volume data except the spatial information and the motion information. The spatial relationships define relative positions and distances between different parts of the human skeleton and other objects or surfaces in the target space TS. The temporal data records how the skeleton moves over time in the target space TS, so as to facilitate motion tracking. The surface and volume data can provide information about the surface and volume of the skeleton, which can be used for collision detection and interaction with the environment.

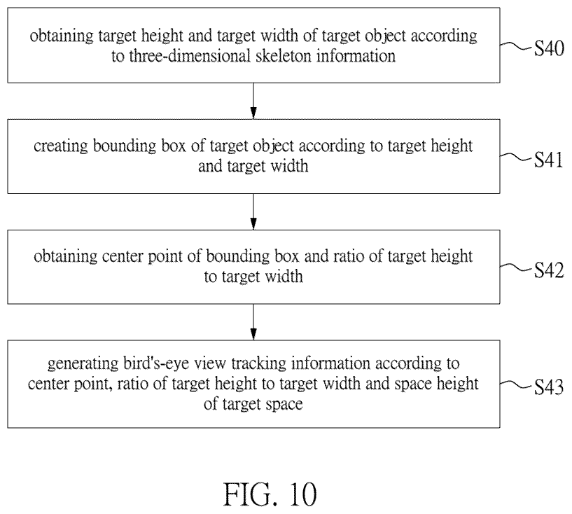

Moreover, referring to FIG. 10, the three-dimensional tracking information of the target object O1 obtained in step S13 further includes bird's-eye view tracking information, which can be obtained by performing following processes using the processing circuit 12:

Step S40: obtaining the target height and a target width of the least one target object according to the three-dimensional skeleton information.

Step S41: creating a bounding box of the at least one target object according to the target height and the target width.

Step S42: obtaining a center point of the bounding box and a ratio of the target height to the target width.

Step S43: generating the bird's-eye view tracking information according to the center point, the ratio of the target height to the target width and the space height of the target space.

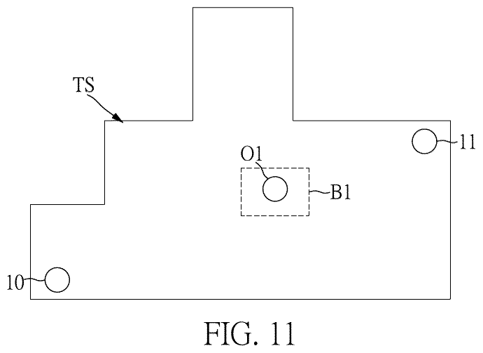

In detail, a target height and a target width of the target object O1 can be obtained after the 3D skeleton of the target object is generated, therefore, an imaginary bounding box of the target object O1 can be created in the 3D layout of the target space TS according to the spatial information. By determining the center of the bounding box and performing coordinate calibration, a bird's eye view can be created. Specifically, the ratio of the target height to the target width can be used to determine the pose of the target object O1, such as in a standing pose or a lying pose, such that the bounding box B1 can be correctly arranged in the 3D layout. In short, the bounding box is converted into a bird's eye view point, and consecutive bird's eye view points are used to achieve tracking functionality, as shown in FIG. 11.

Referring to FIG. 1 again, the image capturing device 134 can also be included in the transmitter 10 or the receiver 11, and the processing circuit 12, which is singular or plural, can be included in one or more of the user equipment 13, the network devices and/or the host device 15 located in the target space TS, and the cloud server 17. Moreover, the user can input images of family individuals in the house to the processing circuit 12, thereby identifying specific person when movements are detected by performing face detection through real-time video captured by the image capturing device 134. However, the aforementioned details are disclosed for exemplary purposes only, and are not meant to limit the scope of the present disclosure.

For further applications, the spatial information and the motion information can be fused to detect and track the actions and movements of the target object O1 in the target space TS and display such information on the user equipment 13 for the user to monitor the safety of the target object and the security of the environment. When the object tracking system and the object tracking method provided by the present disclosure are applied in an automobile environment, the motion of each individual at their seats can be monitored as the spatial information provides seat locations and the motion information provides presence and motion of individual whose age and gender may also be determined.

### Beneficial Effects of the Embodiments

In conclusion, in the object tracking system and the object tracking method provided by the present disclosure, the use of WI-FI sensing technology can be extended into tracking application by combining the spatial information with the motion information, so as to achieve precise three-dimensionally position and motion tracking.

Moreover, the object tracking system and the object tracking method provided by the present disclosure are suitable for various scenarios, the user can monitor the environment with the application program on the user equipment showing the bird's eye view of the target space. Moreover, the user can input images of family individuals in the environment for the information processing module to identify specific person when movements are detected.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An object tracking system, comprising:
a transmitter configured to transmit wireless signals through a target space;
a receiver configured to receive the wireless signals; and
at least one processing circuit configured to perform following processes:
obtaining the wireless signals received by the receiver;
generating motion information associated with at least one target object by executing a motion machine-learning model that processes the received wireless signals; and
generating three-dimensional tracking information of the at least one target object with respect to the target space by fusing spatial information of the target space and the motion information.

2. The object tracking system according to claim 1, further comprising:
an image capturing device configured to capture at least one panoramic image of the target space;
wherein the at least one processing circuit is further configured to perform following processes:
generating the spatial information by executing a spatial machine-learning model that converts the at least one panoramic image into three-dimensional layout information of the target space.

3. The object tracking system according to claim 1, wherein the wireless signals are WI-FI signals.

4. The object tracking system according to claim 1, wherein the motion machine-learning model is executed by the at least one processing circuit to perform following process:
extracting features associated with the at least one target object from the received wireless signals;
converting the features associated with the at least one target object into three-dimensional skeleton information of the at least one target object; and
continuously recording the three-dimensional skeleton information to generate the motion information associated with the at least one target object.

5. The object tracking system according to claim 4, wherein the motion machine-learning model is trained by following processes:
collecting paired training wireless signals and training images, wherein each of training images is marked with training skeleton information; and
inputting the paired training wireless signals and training images to an initial model;
training the initial model to detect skeleton information from the training wireless signals, so as to obtain the motion machine-learning model.

6. The object tracking system according to claim 5, wherein each of training images is marked with the training skeleton information by using a trained pose-detecting model.

7. The object tracking system according to claim 4, wherein the three- dimensional tracking information of the at least one target object with respect to the target space is generated by performing following processes using the at least one processing circuit:
estimating a target height of the at least one target object and a space height of the target space by mapping the three-dimensional skeleton information to the three-dimensional layout information;
comparing the target height and the space height to estimate positional information of the at least one target object with respect to the transmitter and the receiver;
determining a gesture of the at least one target object according to the three-dimensional skeleton information; and
continuously monitoring the positional information and the gesture of the at least one target object to generate the three-dimensional tracking information.

8. The object tracking system according to claim 7, wherein the three-dimensional tracking information of the at least one target object further comprises bird's-eye view tracking information, which is obtained by performing following processes using the at least one processing circuit:
obtaining the target height and a target width of the least one target object according to the three-dimensional skeleton information;
creating a bounding box of the at least one target object according to the target height and the target width;
obtaining a center point of the bounding box and a ratio of the target height to the target width;
generating the bird's-eye view tracking information according to the center point, the ratio of the target height to the target width and the space height of the target space.

9. The object tracking system according to claim 1, wherein the image capturing device is included in a user equipment, the transmitter or the receiver, and the at least one processing circuit is included in the user equipment, a network device located in the target space and/or a cloud server;
wherein the user equipment is configured to receive and display the three-dimensional tracking information of the at least one target object with respect to the target space.

10. An object tracking method, comprising:
configuring a transmitter to transmit wireless signals through a target space;
configuring a receiver to receive the wireless signals; and
configuring at least one processing circuit to perform following processes:
obtaining the wireless signals received by the receiver;
generating motion information associated with at least one target object by executing a motion machine-learning model that processes the received wireless signals; and
generating three-dimensional tracking information of the at least one target object with respect to the target space by fusing spatial information of the target space and the motion information.

11. The object tracking method according to claim 10, further comprising: configuring an image capturing device to capture at least one panoramic image of the target space;
configuring the at least one processing circuit to perform following processes:
generating the spatial information by executing a spatial machine-learning model that converts the at least one panoramic image into three-dimensional layout information of the target space.

12. The object tracking method according to claim 10, wherein the wireless signals are WI-FI signals.

13. The object tracking method according to claim 10, wherein the motion machine-learning model is executed by the processing circuit to perform following process:
extracting features associated with the at least one target object from the received wireless signals;
converting the features associated with the at least one target object into three-dimensional skeleton information of the at least one target object;
continuously recording the three-dimensional skeleton information to generate the motion information associated with the at least one target object.

14. The object tracking method according to claim 13, wherein the motion machine-learning model is trained by following processes:
collecting paired training wireless signals and training images, wherein each of training images is marked with training skeleton information; and
inputting the paired training wireless signals and training images to an initial model;
training the initial model to detect skeleton information from the training wireless signals, so as to obtain the motion machine-learning model.

15. The object tracking method according to claim 14, wherein each of training images is marked with the training skeleton information by using a trained pose-detecting model.

16. The object tracking method according to claim 13, wherein the three-dimensional tracking information of the at least one target object with respect to the target space is generated by performing following processes using the at least one processing circuit:
estimating a target height of the at least one target object and a space height of the target space by mapping the three-dimensional skeleton information to the three-dimensional layout information;
comparing the target height and the space height to estimate positional information of the at least one target object with respect to the transmitter and the receiver;
determining a gesture of the at least one target object according to the three-dimensional skeleton information; and
continuously monitoring the positional information and the gesture of the at least one target object to generate the three-dimensional tracking information.

17. The object tracking method according to claim 16, wherein the three-dimensional tracking information of the at least one target object further comprises bird's-eye view tracking information, which is obtained by performing following processes using the at least one processing circuit:
obtaining the target height and a target width of the least one target object according to the three-dimensional skeleton information;
creating a bounding box of the at least one target object according to the target height and the target width;
obtaining a center point of the bounding box and a ratio of the target height to the target width;
generating the bird's-eye view tracking information according to the center point, the ratio of the target height to the target width and the space height of the target space.

18. The object tracking method according to claim 10, wherein the image capturing device is included in a user equipment, the transmitter or the receiver, and the at least one processing circuit is included in the user equipment, a network device located in the target space and/or a cloud server;
wherein the user equipment is configured to receive and display the three-dimensional tracking information of the at least one target object with respect to the target space.

19. An object tracking method, adapted to a user equipment including a processor and a memory storing a plurality of executable instructions, and the object tracking method comprising:
configuring the processor to execute the plurality of executable instructions to perform following processes:
configuring an image capturing device to capture at least one panoramic image of a target space;
obtaining spatial information generated by executing a spatial machine-learning model that converts the at least one panoramic image into three-dimensional layout information of the target space;
transmitting the spatial information to a network device or a cloud server, wherein the network device or the cloud server is configured to obtain wireless signals received by a receiver, generate motion information associated with at least one target object by executing a motion machine-learning model that processes the received wireless signals, and generate three-dimensional tracking information of the at least one target object with respect to the target space by fusing the spatial information and the motion information; and
receiving the three-dimensional tracking information of the at least one target object with respect to the target space, and displaying the three-dimensional tracking information by a user interface of a tracking application program executed by the user equipment.

20. The object tracking method according to claim 19, wherein the image capturing device is included in the user equipment, a transmitter or the receiver, and the user equipment controls the image capturing device through the user interface.
